(19) United States
(12) Patent Application Publication
(10) Pub. No.: US 2024/0069960 A1
(43) Pub. Date: Feb. 29, 2024

(54) STATE CHANGE FOR WORKFLOW AUTOMATION

(71) Applicant: PREFECT TECHNOLOGIES, INC., Washington, DC (US)

(72) Inventors: Jeremiah Leeam Lowin, Washington, DC (US); Christopher D. White, Half Moon Bay, CA (US)

(21) Appl. No.: 18/237,743

(22) Filed: Aug. 24, 2023

Related U.S. Application Data
(60) Provisional application No. 63/373,450, filed on Aug. 24, 2022.

(51) Int. Cl. G06F 9/48

(52) U.S. Cl. CPC G06F 9/485; G06F 9/4881

(57) ABSTRACT

Techniques are provided for orchestrating runs of a task or workflow. The techniques include: (a) receiving, by an orchestration engine running on the computing device, a request from a run of a task or workflow to transition states from an initial state to a proposed target state; (b) assessing, by the orchestration engine with reference to a set of orchestration rules, whether the run is permitted to transition from the initial state to the proposed target state; and (c) in response to the orchestration engine determining that the run is permitted to transition states, writing the state change to a database and returning permission to the run to transition states.

### CROSS REFERENCE TO RELATED APPLICATIONS

This application claims priority under 35 USC § 119(e) to U.S. Provisional Patent Application Ser. No. 63/373,450, titled “STATE CHANGE FOR WORKFLOW AUTOMATION,” filed Aug. 24, 2022, which is hereby incorporated herein in its entirety by this reference.

### BACKGROUND

Certain tasks may be repeated with some degree of frequency on computing systems. Some computing systems employ workflows to group tasks together and to automate scheduling of such tasks and workflows.

In some computing systems, workflows may be executed locally by a company. In other computing systems, a remote service may be used to execute workflows on behalf of a remote client.

### SUMMARY

Local execution of workflows may not be optimal because there may be a need to orchestrate between various client sites or because users may wish to administer the workflow management from the cloud. However, remote workflow execution may not be an option for many companies because they do not want private or secure data to leave their local networks. Some systems allow workflows to be orchestrated remotely but the code of the workflows executes locally in a client system without sending sensitive data to the remote orchestration server. An example of such a system is described in US Patent Publication 2021/0034443, the entire content and teaching of which is hereby incorporated herein by this reference.

In a system employing remote orchestration of workflows (or even in a system employing similar orchestration techniques locally), states may be used to keep track of the execution of a task or workflow. Certain state transitions may be permitted while others are not. In order to enforce such state transition restrictions, it would be desirable to utilize a set of rules to verify that the states are transitioning properly. This may be accomplished by implementing an order-independent extensible rule-based system to verify state transitions for tasks and workflows.

### BRIEF DESCRIPTION OF THE DRAWINGS

The foregoing and other objects, features, and advantages will be apparent from the following description of particular embodiments, as illustrated in the accompanying drawings in which like reference characters refer to the same parts throughout the different views. The drawings are not necessarily to scale, emphasis instead being placed upon illustrating the principles of various embodiments.

FIG. 1 illustrates an example system, apparatus, computer program product, and associated data structures for use in connection with one or more embodiments.

FIG. 2 illustrates an example method in accordance with one or more embodiments.

FIG. 3 illustrates an example state transition diagram for a workflow in accordance with one or more embodiments.

FIG. 4 illustrates an example state transition diagram for a task in accordance with one or more embodiments.

FIG. 5 illustrates an example method in accordance with one or more embodiments.

### DETAILED DESCRIPTION

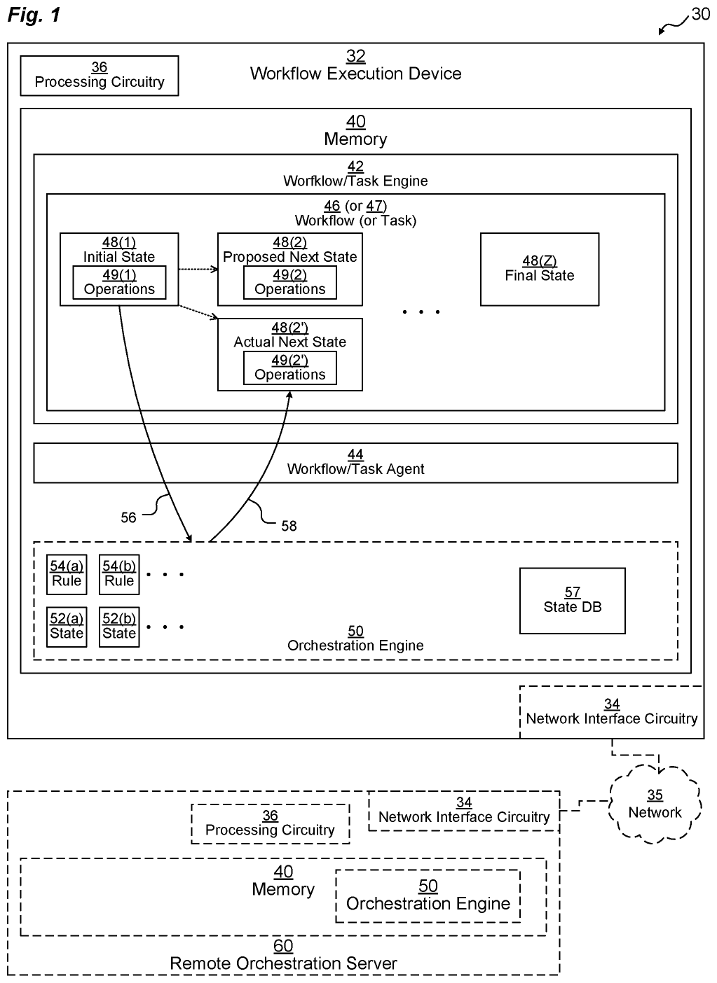

FIG. 1 depicts an example system 30 for use in connection with various embodiments. System 30 includes a workflow execution device 32. In some embodiments, system 30 may also include a remote orchestration server 60 and a network 35.

Network 35 may be any kind of communications network or set of communications networks, such as, for example, a LAN, WAN, SAN, the Internet, a wireless communication network, a virtual network, a fabric of interconnected switches, etc.

Both workflow execution device 32 and remote orchestration server 60 may be any kind of computing device, such as, for example, a personal computer, laptop, workstation, server, enterprise server, tablet, smartphone, etc. Both workflow execution device 32 and remote orchestration server 60 may include processing circuitry 36, network interface circuitry 34, and memory 40. Both workflow execution device 32 and remote orchestration server 60 may also include various additional features as is well-known in the art, such as, for example, user interface circuitry, interconnection buses, etc.

Processing circuitry 36 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 34 may include one or more Ethernet cards, cellular modems, Fibre Channel (FC) adapters, InfiniB and adapters, wireless networking adapters (e.g., Wi-Fi), and/or other devices for connecting to a network 35.

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 36 as well as various data.

Memory 40 of workflow execution device 32 stores a workflow/task execution engine 42 and a workflow/task agent 44. In some embodiments, memory 40 of workflow execution device 32 also stores an orchestration engine 50. In other embodiments, orchestration engine 50 may instead be located remote to the workflow execution device 32 on remote orchestration server 60.

In operation, workflow/task execution engine 42 executes a workflow 46 and/or a task 47. A workflow 46 may include a sequence or set of tasks 47.

A workflow 46 is a container for workflow logic and allows users to interact with and reason about the state of their workflows. Workflows 46 are similar to functions. They can take inputs, perform work, and return an output. When a function becomes a workflow 46, its behavior changes, giving it the following advantages:
State transitions are reported to the API, allowing observation of workflow execution.
Input argument types can be validated.
Retries can be performed on failure.
Timeouts can be enforced to prevent unintentional, long-running workflows 46.

Workflows 46 can include calls to tasks 47 as well as to other workflows 46. In some embodiments, all tasks 47 must be called from within a workflow 46; tasks 47 may not be called from other tasks 47.

A subflow run is created when a workflow function is called inside the execution of another workflow 46. The primary workflow 46 is the “parent” flow. The workflow 46 created within the parent is the “child” flow or “subflow.” Subflow runs behave like normal workflow runs. There is a full representation of the workflow run in the backend as if the workflow 46 had been called separately. When a subflow starts, the subflow will create a new task runner for tasks within the subflow. When the subflow completes, the task runner is shut down. Subflows typically block execution of the parent workflow 46 until completion. However, asynchronous subflows can be run in parallel. Subflows differ from normal workflows 46 in that they will resolve any passed task futures into data. This allows data to be passed from the parent workflow 46 to the child easily. The relationship between a child and parent workflow 46 may be tracked by creating a special task run in the parent workflow 46. This task run will mirror the state of the child flow run. A task 47 that represents a subflow may be annotated as such in details.

A workflow 46 or a task 47 may be configured to operate in various operational states 48 (depicted as states 48(1), 48(2), 48(2′), . . . , 48(Z)). While a workflow 46 or task 47 operates in a particular operational state 48(X), processing circuitry 36 may be configured to execute operations 49(X) associated with that workflow 46 or task 47 in that state 48(X) (e.g., by executing code stored on workflow execution device 32 in connection with that workflow 46 or task 47 in that state 48(X)).

When a workflow 46 or a task 47 completes the operations 49(1) for an initial state 48(1), the workflow 46 or task 47 may attempt to transition to a different state (e.g., proposed next state 48(2)). Workflow/task agent 44 may monitor the workflow 46 or a task 47 for such state transitions. In response, workflow/task agent 44 sends a state transition request 56 to the orchestration engine 50. Orchestration engine 50 is configured to recognize a plurality of states 52 (depicted as states 52(a), 52(b), . . . ). Orchestration engine 50 also stores a plurality of transition rules 54 (depicted as rules 54(a), 54(b), . . . ). Transition rules 54 determine whether particular state transitions are allowed and under what circumstances. In an embodiment, all transition rules 54 are evaluated in response to a state transition request 56. As a preliminary step in this evaluation, it may first be determined whether a rule 54 is relevant by assessing whether that rule 54 can be applied to the requested state transition. If not, that rule 54 is skipped. Rules 54 may be evaluated in any order. “Orchestration” is a state-based determination of whether a state transition is permissible, including scheduling of runs. Orchestration is performed by orchestration engine 50. “Execution” is a code-based determination of what state to enter. Execution is performed by each run itself.

The final state 48(Z) of a workflow 46 is determined by its return value. The following rules apply:
If an exception is raised directly in the workflow function, the workflow run is marked as failed.
If the workflow 46 does not return a value (or returns None), its final state 48(Z) is determined by the final states 48(Z) of all of the tasks 47 and subflows within it. In particular, if any task run or subflow run failed, then the final state 48(Z) of the workflow 46 is marked as failed.
If a workflow 46 returns a manually created state, it is used as the state of the final workflow run. This allows for manual determination of final state 48(Z).
If the workflow run returns any other object, then it is marked as completed.

A task 47 is a function that represents a discrete unit of work in a workflow 46. A workflow 46 need not contain any tasks 47—it is possible for a workflow 46 to contain logic and subflows without calling any tasks 47. Tasks 47 are special because they may receive metadata about upstream dependencies and the state 52 of those dependencies before they run, even if the tasks 47 don't receive any explicit data inputs. This allows a task 47 to wait on the completion of another task 47 before executing. Tasks 47 also take advantage of automatic logging to capture details about task runs such as runtime, tags, and final state 48(Z). Tasks 47 can automatically retry on failure. A new task run is not created when a task 47 is retried.

Results of tasks 47 (“task results”) may be cached in memory 40 during execution of a run of a workflow 46. Caching refers to the ability of a task run to reflect a finished state 48(Z) without actually running the code that defines the task 47. This allows for efficient reuse of results of tasks 47 that may be expensive to run with every workflow run by reusing cached task results if the inputs to a task 47 have not changed. Thus, task results are available within the context of a workflow run and task retries may use these task results. A new state 48 is added to a state history of the original task run.

To determine whether a task run should retrieve a cached state, “cache keys” may be used. A cache key is a string value that indicates if one run should be considered identical to another. When a task run with a cache key finishes, that cache key is attached to its state 48(Z). When each task run starts, workflow/task engine 42 checks for finished states 48(Z) with a matching cache key. If a finished state 48(Z) with an identical key is found, workflow/task engine 42 will use the cached state instead of running the task 47 again.

There may arise situations in which there may be a need to actively prevent too many tasks 47 from running simultaneously. For example, if many tasks 47 across multiple workflows 46 are designed to interact with a database that only allows 10 connections, it is desirable to make sure that no more than 10 tasks 47 that connect to this database are running at any given time. Task concurrency limits may be utilized to achieve this. Task concurrency limits use task tags, which are string labels that may optionally be passed as arguments when calling a task 47. An optional concurrency limit may be passed as the maximum number of concurrent task runs in a state for tasks 47 with a given tag. The specified concurrency limit applies to any task 47 to which the tag is applied. If a task 47 has multiple tags, it will run only if all tags have available concurrency. Tags without explicit limits are considered to have unlimited concurrency. Task tag limits are checked whenever a task run attempts to enter a state 48 of “Running.” If there are no concurrency slots available for any one of the tags of a task 47, the transition to the state 52 of Running will be delayed and the client is instructed to try entering that state 48 again after a waiting period (e.g., 30 seconds).

States 52 are rich objects that contain information about the status of a run of a particular workflow 46 or task 47.

At any moment, the current state 48 or the history of states 48 of a run may provide information about that run, such as, for example:
that a task 47 is scheduled to make a third run attempt in 1 hour
that a task 47 succeeded and what data it produced
that a task 47 was scheduled to run but was later cancelled
that a task 47 used the cached result of a previous run instead of re-running
that a task 47 failed because it timed out

It should be understood that although the state of a workflow 46 or a task 47 is sometimes mentioned, what is really meant is the state of a run of a workflow 46 or of a task 47. Workflows 46 and tasks 47 are templates that describe what a system does; only when the system runs does it also take on a state 48. So while a task 47 might be referred to as “running” or being “successful,” what is really meant is that a specific instance of the task 47 is in that state 48.

States 52 have names and types. State types are canonical, with specific orchestration rules 54 that apply to transitions into and out of each state type. A state's name, is often, but not always, synonymous with its type. For example, a task run that is running for the first time has a state 48 with the name Running and the type Running. However, if the task 47 retries, that same task run will have the name Retrying and the type Running as its state 48. Each time the task run transitions into the Running state, the same orchestration rules 54 are applied.

There are terminal state types from which there are no orchestrated transitions to any other state type:
COMPLETED
CANCELLED
FAILED
CRASHED

An example full complement of states 52 and state types is presented in Table 1.

TABLE 1

| State Name | State Type | Terminal? | Description |
|---|---|---|---|
| Scheduled | SCHEDULED | No | The run will begin at a particular time in the |
| | | | future. |
| Late | SCHEDULED | No | The run's scheduled start time has passed, but it |
| | | | has not transitioned to PENDING (e.g., five |
| | | | seconds by default). |
| Awaiting | SCHEDULED | No | The run did not complete successfully because |
| Retry | | | of a code issue and had remaining retry |
| | | | attempts. |
| Pending | PENDING | No | The run has been submitted to run but is |
| | | | waiting on necessary preconditions to be |
| | | | satisfied. |
| Running | RUNNING | No | The run code is currently executing. |
| Retrying | RUNNING | No | The run code is currently executing after |
| | | | previously not completing successfully. |
| Cancelled | CANCELLED | Yes | The run did not complete because a user |
| | | | determined that it should not. |
| Completed | COMPLETED | Yes | The run completed successfully. |
| Retrieved | COMPLETED | Yes | A previous run having the same inputs |
| Cache | | | completed successfully (if caching is used), and |
| | | | its cached results are used as outputs. |
| Failed | FAILED | Yes | The run did not complete because of a code |
| | | | issue and had no remaining retry attempts. |
| Crashed | CRASHED | Yes | The run did not complete because of an |
| | | | infrastructure issue. |

If the state transition request 56 is approved, orchestration engine 50 records the state transition in a state database (DB) 57 and returns a state transition approval 58 to the workflow/task agent 44. Then workflow/task agent 44 may permit the workflow 46 or task 47 to transition to an actual next state 48(2′). If the state transition request 56 is approved without modification, then the actual next state 48(2′) is the same as the proposed next state 48(2).

Rules 54 can be called either immediately before or after a state transition is “confirmed” (meaning the state transition is recorded in the state DB 57). Rules that run BEFORE a state transition (referred to as “before transition rules” or “before rules”) can return various values to affect the transition:
1. “None” to abort the transition entirely
2. A new proposed state 48(2) type to modify the transition (and abort further rule processing using the previous proposed state 48(2))
3. The provided proposed state 48(2) (possibly with modified details) to affirm the transition and continue rule processing.

Rules that run AFTER a state transition (referred to as “after transition rules” or “after rules”) do not have a return value that can affect the transition; the transition has already happened.

A state-setting pipeline does the following:
1. Based on the types of the initial state 48(1) and the proposed next state 48(2), collects all applicable rules 54 into a “policy pipeline”
2. Builds Rule Parameters from runtime data (such as run counts, IDs, task information like max retries, etc.)
3. Iterates over the rule pipeline, providing the initial state 48(1), proposed next state 48(2), and parameters to each rule 54 in sequence
   a. If a rule 54 returns a state 52:
      i. if the state type didn't change, rule processing continues
      ii. if the state type changed (for example, a FAILED proposed next state 48(2) was provided and a SCHEDULED state was returned), rule processing stops and the most recent is retained as a new proposed next state 48(2)
      iii. if None is returned, rule processing stops and the state transition is aborted
4. The proposed next state 48(2) (after any changes in 3.a.ii) is written to the state DB 57 as the actual next state 48(2′)
5. Iterates over the rule pipeline again, providing the initial state 48(1), actual next state 48(2′), and parameters to each rule 54 in sequence
   a. “after transition” rules are not expected to return anything

In some embodiments, global rules are applied before every transition but after the before rules have run; they are used to modify states 48 immediately before they are recorded. Example global rules are presented in Table 2.

TABLE 2

| | | | | | When |
|---|---|---|---|---|---|
| | | Run | From | | to |
| Rule Name | Description | Type | state(s) | To state(s) | run? |
| Retry on | When run_count < | Task | RUNNING | | |
| Fail | max_retries, await retry in | | | | |
| | retry_delay seconds | | | | |
| Cache | When cache_key is provided | Task | | COMPLETED | |
| Completed | on a Completed state, add it | | | | |
| States | to the cache. | | | | |
| Update | Update key run details on the | Task or | | | Before |
| Run Details | new state | Flow | | | |
| Update | Update key state details on | Task or | | | Before |
| State | the new state | Flow | | | |
| Details | | | | | |

Orchestration rules 54 are applied either before or after a state transition. If applied before, they have an opportunity to change the state 48 or prevent the state transition from happening. If the type of the state 48 is changed by a before rule, then rule processing stops and the new state type is entered. Therefore rules 54 have a priority for deterministic ordering. Example non-global rules 54 are presented in Table 3. A star (*) indicates that all possible states 52 are valid as an initial state 48(1) and/or proposed next state 48(2) for a rule 54, as indicated in Table 3.

TABLE 3

| | | | | | | If | If |
|---|---|---|---|---|---|---|---|
| | | | | | When | before, | before, |
| | | Run | | | to | possible | can |
| Rule Name | Description | Type | From state(s) | To state(s) | run? | response | abort? |
| Evaluate | Evaluate a trigger function | Task | * | RUNNING | Before | Failed | No |
| Trigger | before entering a RUNNING | | | | | | |
| | state, based on upstream states | | | | | | |
| | (that would need to be part of | | | | | | |
| | the rule parameters) | | | | | | |
| Retry on Fail | When run_count < max_retries, | Task | RUNNING | FAILED | Before | Awaiting | Yes |
| | await retry in retry_delay | or | | | | Retry | |
| | seconds | Flow | | | | | |
| Simultaneous | Prevent Running → Running | Task | RUNNING | RUNNING or | Before | | |
| runs | transitions under normal | | | PENDING | | | |
| | circumstances, including to the | | | | | | |
| | Pending state that would | | | | | | |
| | indicate another attempt to run. | | | | | | |
| | As an extension, this rule could | | | | | | |
| | allow these transitions if | | | | | | |
| | heartbeats were sufficiently | | | | | | |
| | stale to enable Lazarus-like | | | | | | |
| | functionality without a service | | | | | | |
| Use cache on | When a cache_key is provided | Task | * | RUNNING | Before | Retrieve | Yes |
| running | on a Running state, attempt to | | | | | Cache | |
| states | retrieve a cached value instead, | | | | | | |
| | and set the correct | | | | | | |
| | cached_task_run_id to indicate | | | | | | |
| | the source | | | | | | |
| Wait until | If a run is scheduled, prevent | Task | SCHEDULED | PENDING | Before | | Yes |
| start time | entering a running state until | | | | | | |
| | the scheduled start time is | | | | | | |
| | reached | | | | | | |
| Cache | When cache_key is provided | Task | * | COMPLETED | After | | Yes |
| completed | on a Completed state, add it to | | | | | | |
| states | the cache. | | | | | | |
| Cancel | When a flow run is put in a | Flow | * | CANCELLED | After | | |
| running tasks | Cancelled state, put all running | | | | | | |
| | tasks in a Cancelled state as | | | | | | |
| | well | | | | | | |
| Expire cache | When a task in a completed | Task | COMPLETED | * | After | | |
| | state that is also in the cache is | | | | | | |
| | taken OUT of that completed | | | | | | |
| | state for any reason, | | | | | | |
| | automatically expire any state | | | | | | |
| | caches that reference it | | | | | | |
| Linear | Whenever a flow run enters a | Flow | SCHEDULED | PENDING | Before | Cancelled | |
| schedules | pending state AND is auto- | | | | | | |
| | scheduled, prevent it from | | | | | | |
| | running if it has linear | | | | | | |
| | scheduling enabled | | | | | | |
| Return | Return a concurrency slot after | Task | RUNNING | * | After | | |
| concurrency | running | or | | | | | |
| | | Flow | | | | | |
| Subflow | Whenever a subflow run | Flow | * | * | After | | Yes |
| parent task | changes state, its parent task is | | | | | | |
| state | put in the identical state | | | | | | |
| Secure | When a state runs, secure a | Task | * | RUNNING | Both | Queued | |
| concurrency | concurrency slot. | or | | | | | |
| | | Flow | | | | | |
| Webhook | Whenever a state transition | Task | * | * | Both | * | |
| rules | takes place, hit user- | or | | | | | |
| | configurable webhooks to | Flow | | | | | |
| | enable custom behavior. Before | | | | | | |
| | webhooks must comply with | | | | | | |
| | the signature of a before | | | | | | |
| | transition hook; after webhooks | | | | | | |
| | are read-only | | | | | | |
| Prevent | Normal orchestration doesn't | Task | COMPLETED, | * | Before | | Yes |
| “normal” | transition through certain final | or | CANCELLED, | | | | |
| transitions | states, so we block these | Flow | OR FAILED | | | | |
| out of | transitions to ensure effective | | | | | | |
| terminal | coordination among many | | | | | | |
| states | parties | | | | | | |

Memory 40 may also store various other data structures used by the OS, workflow/task execution engine 42, workflow/task agent 44, orchestration engine 50, and/or various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32, 60 is powered off. The OS, workflow/task execution engine 42, workflow/task agent 44, orchestration engine 50, and/or various other applications and drivers are typically stored in this persistent storage portion of memory 40 so that they may be loaded into a system portion of memory 40 upon a system restart or as needed. The OS, workflow/task execution engine 42, workflow/task agent 44, orchestration engine 50, and/or various other applications and drivers, when stored in non-transitory form either in the volatile or persistent portion of memory 40 (which may be referred to as a non-transitory computer-readable storage medium), each form a computer program product. The processing circuitry 36 running one or more applications thus forms a specialized circuit constructed and arranged to carry out the various processes described herein.

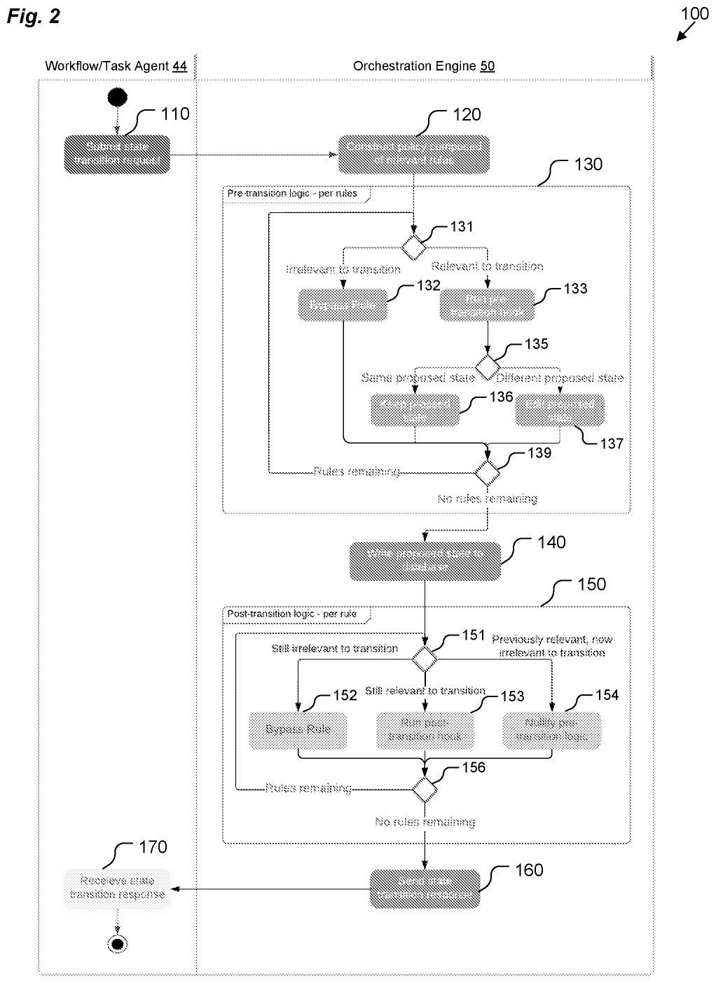

FIG. 2 illustrates an example method 100 performed by a system 30 for utilizing a set of rules 54 to maintain state consistency. It should be understood that any time a piece of software (e.g., OS, workflow/task execution engine 42, workflow/task agent 44, orchestration engine 50, etc.) is described as performing a method, process, step, or function, what is meant is that a computing device (e.g., workflow execution device 32 or remote orchestration server 60) on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order.

In step 110, workflow/task agent 44 submits a state transition request 56 to orchestration engine 50 on behalf of workflow/task execution engine 42. In response, in step 120, orchestration engine 50 constructs a policy made up of relevant rules 54.

In step 130, orchestration engine 50 applies pre-transaction logic on a per-rule basis. In sub-step 131, orchestration engine 50 evaluates a rule 54(X) to assess whether it has any relevance to the requested state transition. This relevance determination looks at what initial and target states the rule 54(X) applies to; the rule 54(X) is only considered relevant if BOTH (A) the initial state 48(1) is listed as a valid initial state for the rule 54(X) AND (B) the proposed next state 48(2) is listed as a valid target state for the rule 54(X). In some embodiments, the relevance determination may also look at whether the rule 54(X) applies to a workflow 46, a task 47, or both; the rule 54(X) is only considered relevant if the state transition request 56 was about the listed type for the rule 54(X). For example, if a rule 54(X) only applies to workflows 46, but the state transition request 56 was about a task 47, then the rule 54(X) is irrelevant. In some embodiments, the relevance determination may also look at whether the rule 54(X) is meant to be applied before a state transition, after a state transition, or both; the rule 54(X) is only considered relevant at the appropriate time.

If the rule 54(X) is determined to be not relevant at sub-step 131, then, in sub-step 132, orchestration engine 50 bypasses that rule 54(X) and proceeds to sub-step 139.

As an example, with reference to the example rules listed in Tables 2 and 3, if the initial state 48(1) was “Scheduled” and the proposed next state 48(2) was “Running” for a workflow 46, then Table 4 below indicates whether each rule is relevant in sub-step 131 and why:

TABLE 4

| Rule Name | Relevant? | Why? |
|---|---|---|
| Evaluate trigger | No | Not a task |
| Retry on fail | No | Not a task; wrong initial and target states |
| Simultaneous runs | No | Wrong initial state |
| Use Cache on Running States | No | Not a task |
| Wait until Start Time | No | Wrong target state |
| Cache Completed States | No | Not a task; wrong target state; wrong time |
| (Orchestration) | | |
| Cancel running tasks | No | Wrong target state; wrong time |
| Expire caches | No | Not a task; wrong initial state; wrong time |
| Linear Schedules | No | Wrong target state |
| Return concurrency | No | Wrong initial state; wrong time |
| Subflow Parent Task State | No | Wrong time |
| Secure concurrency | Yes | Correct initial and target states; correct time; |
| | | flow |
| Webhook Rules | Yes | Correct initial and target states; correct time; |
| | | flow |
| Prevent “normal” transitions out | No | Wrong initial state |
| of terminal states | | |
| Retry on fail | No | Not a task; wrong initial and target states |
| Cache Completed States (Global) | No | Not a task; wrong target state |
| Update run details | Yes | Correct initial and target states; correct time; |
| | | flow |
| Update state details | Yes | Correct initial and target states; correct time; |
| | | flow |

If the rule 54(X) is determined to be relevant in sub-step 131, then, in sub-step 133, orchestration engine 50 applies that rule 54(X) by running a pre-transition hook. Then, in sub-step 135, orchestration engine 50 evaluates whether application of the rule 54(X) actually results in the proposed next state 48(2); if so, then in sub-step 136, orchestration engine 50 maintains the proposed next state 48(2). Otherwise (i.e., if the application of the rule 54(X) is determined not to have resulted in the proposed next state 48(2) in sub-step 135), in sub-step 137, orchestration engine 50 edits the proposed next state 48(2) to yield a different state 52.

In sub-step 139, orchestration engine 50 assesses whether there are any remaining rules 54 to evaluate. In some embodiments, every rule 54 is evaluated (for relevancy with further evaluation if relevant). If the orchestration engine 50 determines that there are remaining rules 54 to evaluate at sub-step 139, operation proceeds back to sub-step 131 for the next rule 54(X+1). If the orchestration engine 50 determines that there are not remaining rules 54 to evaluate at sub-step 139, operation proceeds with step 140. In some embodiments, if the proposed next state 48(2) was modified in sub-step 137, then step 130 begins iterating through the rules 54 again using the updated proposed next state 48(2).

In step 140, orchestration engine 50 writes the proposed next state 48(2) (as edited in response to application of the rules 54 during step 130) to the state DB 57 and then proceeds to step 150. Continuing in the above example from Table 1, if the “Secure Concurrency” rule determines that there are too many concurrent flows running, then the rule 54 would edit the proposed next state 48(2) to be “QUEUED (SCHEDULED)” instead of “RUNNING.”

In step 150, orchestration engine 50 applies post-transaction logic on a per-rule basis. In sub-step 151, orchestration engine 50 evaluates a rule 54(X) to assess whether that rule 54(X) still has any relevance to the requested state transition. If the orchestration engine 50 determines that the rule 54(X) is still not relevant at sub-step 151, then, in sub-step 152, orchestration engine 50 bypasses that rule 54(X) and proceeds to sub-step 156. If the orchestration engine 50 determines in sub-step 151 that rule 54(X) was previously relevant but is now no longer relevant, then, in sub-step 154, orchestration engine 50 “fizzles” that rule 54(X) by nullifying the pre-transaction logic for that rule 54(X) and proceeds to sub-step 156.

Continuing in the above example from Table 1, with continued reference to the example rules listed in Appendix 4, since the initial state 48(1) is “SCHEDULED” and the edited proposed next state 48(2) is “QUEUED (SCHEDULED)” for a workflow 46, then Table 5 below indicates whether each rule 54 is relevant in sub-step 151 and why:

TABLE 5

| Rule Name | Relevant? | Why? |
|---|---|---|
| Evaluate trigger | No | Not a task; wrong initial and target states; |
| | | wrong time |
| Retry on fail | No | Not a task; wrong initial and target states; |
| | | wrong time |
| Simultaneous runs | No | Wrong initial and target states; wrong time |
| Use Cache on Running States | No | Wrong target state; not a task; wrong time |
| Wait until Start Time | No | Wrong target state; wrong time |
| Cache Completed States | No | Not a task; wrong target state |
| (Orchestration) | | |
| Cancel running tasks | No | Wrong target state |
| Expire caches | No | Not a task; wrong initial state |
| Linear Schedules | No | Wrong target state; wrong time |
| Return concurrency | No | Wrong initial state |
| Subflow Parent Task State | Yes | Correct initial and target states; correct time; |
| | | flow |
| Secure concurrency | Fizzled | Wrong target state |
| Webhook Rules | Yes | Correct initial and target states; correct time; |
| | | flow |
| Prevent “normal” transitions out | No | Wrong initial state; wrong time |
| of terminal states | | |
| Retry on fail | No | Not a task; wrong initial and target states |
| Cache Completed States (Global) | No | Not a task; wrong target state |
| Update run details | Fizzled | Wrong time |
| Update state details | Fizzled | Wrong time |

If the orchestration engine 50 determines in sub-step 151 that rule 54(X) remains relevant, then, in sub-step 153, orchestration engine 50 applies that rule 54(X) by running a post-transition hook.

In sub-step 156, orchestration engine 50 assesses whether there are any remaining rules 54 to evaluate. If the orchestration engine 50 determines that there are remaining rules 54 to evaluate at sub-step 156, operation proceeds back to sub-step 151 for the next rule 54(X+1). If the orchestration engine 50 determines that there are not any remaining rules 54 to evaluate at sub-step 156, operation proceeds with step 160.

In step 160, orchestration engine 50 sends a state transition approval 58 for the (edited) proposed next state 48(2) back to the workflow/task agent 44. In some embodiments, orchestration engine 50 also logs the state transition approval 58 for the (edited) proposed next state 48(2) together with a listing of which rules 54 were applied. In some of these embodiments, one or all reasons why each irrelevant rule 54 was considered irrelevant is also logged. In step 170, workflow/task agent 44 receives the state transition approval 58 and directs the workflow/task execution engine 42 to enter the (edited) proposed next state 48(2), which becomes the actual next state 48(2′).

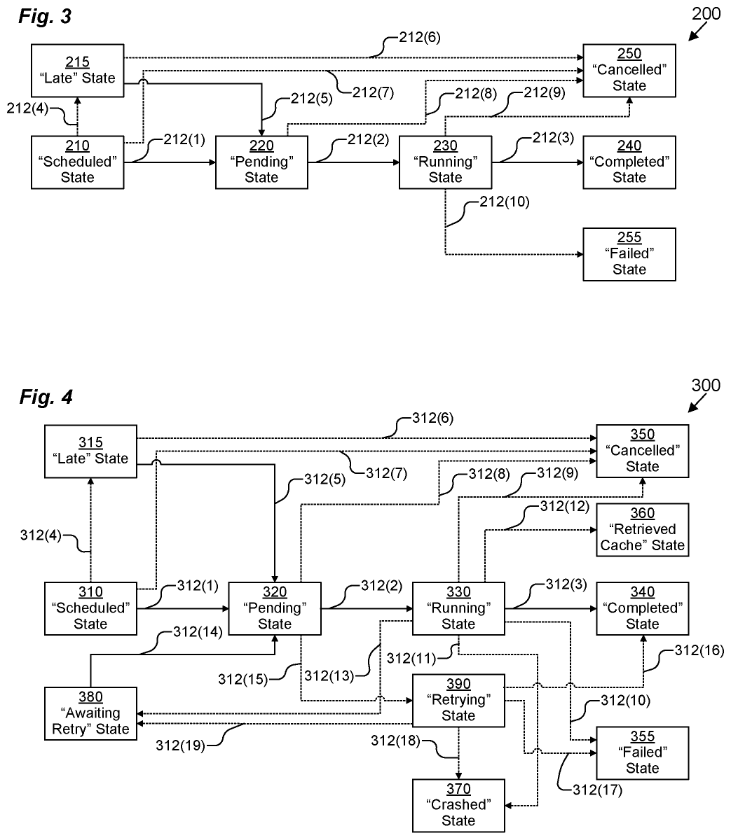

FIG. 3 depicts an example state transition diagram 200 for workflows 46. State transition diagram 200 shows all valid transitions 212 between states 48 in an example embodiment.

As depicted, in the normal course of operation a scheduled state 210 attempts to transition via state transition 212(1) to pending state 220 (when a scheduled time for execution is reached), which then attempts to transition via state transition 212(2) to running state 230 (once there are no remaining concurrency limits), which then attempts to transition via state transition 212(3) to completed state 240 upon successful completion.

If the scheduled time for execution passes without transition to the pending state 220, then scheduled state 210 instead attempts to transition via state transition 212(4) to late state 215. In a normal course, late state 215 attempts to transition via state transition 212(5) to pending state 220 as soon as possible. If a user instructs the workflow 46 to be cancelled, then, depending on the current state 48, late state 215 attempts to transition via state transition 212(6) to cancelled state 250, scheduled state 220 attempts to transition via state transition 212(7) to cancelled state 250, pending state 220 attempts to transition via state transition 212(8) to cancelled state 250, or running state 230 attempts to transition via state transition 212(9) to cancelled state 250. If running state 230 does not complete successfully (e.g., because of a code issue), then it attempts to transition via state transition 212(10) to failed state 255.

FIG. 4 depicts an example state transition diagram 300 for tasks 47. State transition diagram 300 shows all valid transitions 312 between states 48 in an example embodiment.

As depicted, in the normal course of operation a scheduled state 310 attempts to transition via state transition 312(1) to pending state 320 (when a scheduled time for execution is reached), which then attempts to transition via state transition 312(2) to running state 330 (once there are no remaining concurrency limits), which then attempts to transition via state transition 312(3) to completed state 340 upon successful completion.

If the scheduled time for execution passes without transition to the pending state 320, then scheduled state 310 instead attempts to transition via state transition 312(4) to late state 315. In a normal course, late state 315 attempts to transition via state transition 312(5) to pending state 320 as soon as possible. If a user instructs the task 47 to be cancelled, then, depending on the current state 48, late state 315 attempts to transition via state transition 312(6) to cancelled state 350, scheduled state 320 attempts to transition via state transition 312(7) to cancelled state 250, pending state 320 attempts to transition via state transition 312(8) to cancelled state 350, or running state 330 attempts to transition via state transition 312(9) to cancelled state 350.

Upon an attempt to enter running state 330, if orchestration manager 50 determines that a cache key for the run is identical to a cache key (stored in state DB 57) for a previously-completed run of the same task 47 (prior to expiration), then running state 330 is bypassed via transition 312(12) to go directly to retrieved cache state 360, which is a COMPLETED type of state 52 that outputs the same results as the previously-completed run of the same task 47 with the same cache key did.

If running state 330 does not complete successfully because of a code issue, then the running state 330 attempts to transition via state transition 312(10) to failed state 355. If there are any remaining retries (i.e., if run_count<max_retries), then orchestration manager 50 does not permit transition 310(10), instead forcing transition 310(13) to the awaiting retry state 380. If running state 330 does not complete successfully because of an infrastructure issue, then it attempts to transition via state transition 312(11) to crashed state 370.

The awaiting retry state 380 attempts to transition via state transition 312(14) to the pending state 320. If the pending state 320 is entered from the awaiting retry state 380, then instead of transitioning to the running state 330, it attempts to transition via state transition 312(15) to the retrying state 390, which then attempts to transition via state transition 312(16) to completed state 340 upon successful completion. If retrying state 390 does not complete successfully because of a code issue, then it attempts to transition via state transition 312(17) to failed state 355. If there are any remaining retries (i.e., if run_count<max_retries), then orchestration manager 50 does not permit transition 310(17), instead forcing transition 310(19) back to the awaiting retry state 380. If retrying state 390 does not complete successfully because of an infrastructure issue, then it attempts to transition via state transition 312(18) to crashed state 370.

It should be understood that although only transitions 312(6), 312(7), 312(8), 312(9) are depicted as going to the cancelled state 350, other states 48 (e.g., states 380, 390) may also be able to transition to the cancelled state 350, but these transitions 312 are omitted for clarity of presentation.

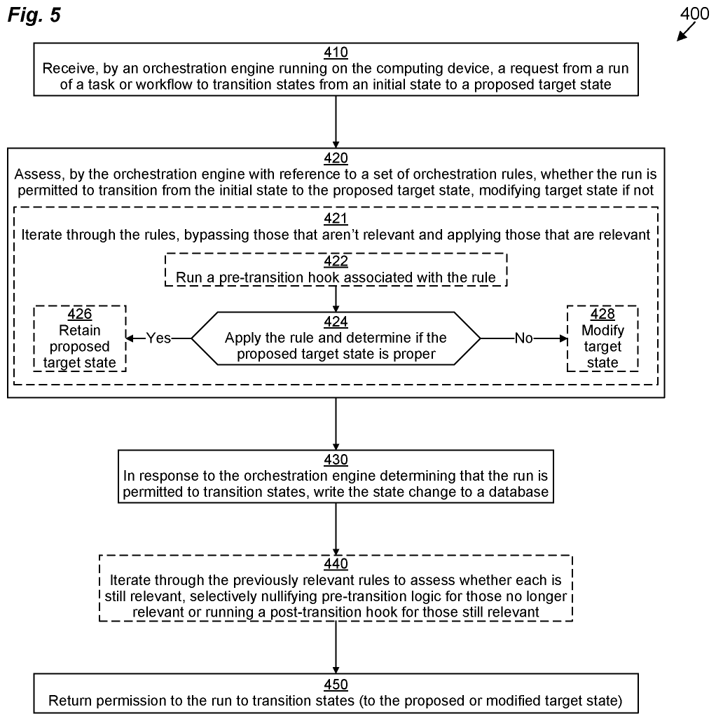

FIG. 5 illustrates an example method 400 performed by a computing device (e.g., remote orchestration server 60 running orchestration engine 50; workflow execution device 32 running orchestration engine 50), of orchestrating runs of a task 47 or workflow 46. It should be understood that one or more of the steps or sub-steps of method 400 may be omitted in some embodiments. Similarly, in some embodiments, one or more steps or sub-steps may be combined together or performed in a different order.

In step 410, orchestration engine 50 receives a request 56 from a run of a task 47 or workflow 4 to transition states 52 from an initial state 48(1) to a proposed target state 48(2).

In response, in step 420, orchestration engine 50 assesses, with reference to a set of orchestration rules 54, whether the run is permitted to transition from the initial state 48(1) to the proposed target state 48(2), modifying the proposed target state 48(2) if not permitted. Step 420 may include sub-step 421, in which orchestration engine 50 iterates through the rules 54, bypassing those rules 54 that are not relevant and applying those rules 54 that are relevant. For each rule 54(X), sub-step 421 may include sub-steps 422, 424, 426, 428.

In optional sub-step 422, orchestration engine 50 runs a pre-transition hook associated with the rule 54(X). Then, in sub-step 424, orchestration engine 50 applies the rule 54(X) and determines whether or not the proposed target state 48(2) is consistent with application of that rule 54(X). If so, then, in sub-step 426, the proposed target state 48(2) is retained, and iteration (returning back to sub-step 422 or 424) proceeds with the next rule 54(X+1) until no more rules 54 remain over which to iterate.

If the proposed target state 48(2) is not consistent with application of rule 54(X), then, in sub-step 428, the proposed target state 48(2) is updated. In some embodiments, after sub-step 428, the iteration through the rules 54 continues, while in other embodiments, after sub-step 428, the iteration through the rules 54 begins again from first rule 54(1). Once no more rules 54 remain that haven't been applied yet in sub-step 424, iteration 421 ends, and step 420 terminates.

In step 430, in response to the orchestration engine 50 determining that the run is permitted to transition to the proposed target state 48(2) (as modified in sub-step 428, if applicable), the (modified) proposed target state 48(2) is written to the state DB 57 as actual next state 48(2′).

In some embodiments, in step 440, orchestration engine 50 iterates through the previously relevant rules 54 to assess whether each is still relevant, selectively nullifying pre-transition logic for those no longer relevant or running a post-transition hook for those that are still relevant. Application of the post-transition hooks should not alter the actual next state 48(2′).

Finally, in step 450, orchestration engine 50 returns approval 58 to the run to transition to the actual next state 48(2′) (which may or may not be the same as the original proposed next state 48(2)).

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes at least one tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

What is claimed is:

1. A method, performed by a computing device, of orchestrating runs of a task or workflow, the method comprising:
receiving, by an orchestration engine running on the computing device, a request from a run of a task or workflow to transition states from an initial state to a proposed target state;
assessing, by the orchestration engine with reference to a set of orchestration rules, whether the run is permitted to transition from the initial state to the proposed target state; and
in response to the orchestration engine determining that the run is permitted to transition states, writing the state change to a database and returning permission to the run to transition states.

2. The method of claim 1, wherein assessing includes iterating through the set of orchestration rules, bypassing rules of the set of orchestration rules that are not relevant to the proposed transition of the run of the task or workflow from the initial state to the proposed target state.

3. The method of claim 2, wherein a rule of the set of orchestration rules is deemed to not be relevant in response to determining that that rule does not cover a transition from the initial state to the proposed target state.

4. The method of claim 3, wherein a rule of the set of orchestration rules is further deemed to not be relevant in response to determining that either:
the run is of a workflow, and that rule applies only to runs of tasks; or
the run is of a task, and that rule applies only to runs of workflows.

5. The method of claim 3, wherein a rule of the set of orchestration rules is further deemed to not be relevant in response to determining that that rule is designated as applying only after a state change has been assessed.

6. The method of claim 2, wherein iterating through the set of orchestration rules includes applying each rule of the set of orchestration rules that is relevant to the proposed transition to determine whether that rule is consistent with the transition from the initial state to the proposed target state.

7. The method of claim 6, wherein iterating through the set of orchestration rules further includes, in response to determining that that rule is not consistent with the transition from the initial state to the proposed target state, modifying the proposed target state to be consistent with that rule.

8. The method of claim 6 wherein iterating through the set of orchestration rules further includes, prior to applying that rule, applying logic of a pre-transition hook associated with that rule.

9. The method of claim 2, wherein the method further includes, after writing the state change to the database and prior to returning permission to the run to transition states, determining whether the rules of the set of orchestration rules that were previously deemed to be relevant to the proposed transition are still relevant.

10. The method of claim 9, wherein the method further includes, in response to determining that a rule of the set of orchestration rules is not still relevant to the proposed transition, nullifying pre-transition logic associated with that rule.

11. The method of claim 9, wherein the method further includes, in response to determining that a rule of the set of orchestration rules is still relevant to the proposed transition, applying logic of a post-transition hook associated with that rule prior to applying that rule again.

12. The method of claim 1, wherein:
the run operates on another computing device across a network;
the request is received from the other computing device via the network; and
the permission is sent to the other computing device via the network.

13. A computer program product comprising at least one non-transitory computer-readable storage medium storing instructions, which, when performed by processing circuitry of a computing device, cause the computing device to orchestrate runs of a task or workflow by:
receiving, by an orchestration engine running on the computing device, a request from a run of a task or workflow to transition states from an initial state to a proposed target state;
assessing, by the orchestration engine with reference to a set of orchestration rules, whether the run is permitted to transition from the initial state to the proposed target state; and
in response to the orchestration engine determining that the run is permitted to transition states, writing the state change to a database and returning permission to the run to transition states.

14. An apparatus comprising processing circuitry coupled to memory configured to orchestrate runs of a task or workflow by:
receiving, by an orchestration engine running on the apparatus, a request from a run of a task or workflow to transition states from an initial state to a proposed target state;
assessing, by the orchestration engine with reference to a set of orchestration rules, whether the run is permitted to transition from the initial state to the proposed target state; and
in response to the orchestration engine determining that the run is permitted to transition states, writing the state change to a database and returning permission to the run to transition states.
